(19) United States
(12) Patent Application Publication
(10) Pub. No.: US 2018/0283363 A1
(43) Pub. Date: Oct. 4, 2018

(54) SPRING UNIT, SPRING ACCUMULATOR, AND ACTUATOR

(71) Applicant: SIEMENS AKTIENGESELLSCHAFT, München (DE)

(72) Inventors: Georg Bachmaier, München (DE); Thomas Vontz, München (DE); Wolfgang Zöls, München-Lochhausen (DE); Hans-Georg von Garssen, Höhenkirchen (DE)

(21) Appl. No.: 15/764,874

(22) PCT Filed: Sep. 28, 2016
(86) PCT No.: PCT/EP2016/073135

§ 371 Date: Mar. 29, 2018

(30) Foreign Application Priority Data
Sep. 30, 2015 (DE) 10 2015 218 851.5

(51) Int. Cl. F03G 1/10; F16F 15/067

(52) U.S. Cl. CPC F03G 1/10; F16F 2230/0064; F16F 15/067

(57) ABSTRACT

The invention relates to a spring unit, a spring accumulator, and an actuator. The spring unit comprises at least one spring element, which has a part that can be deflected against a spring force, and a compensation device, which is designed to counteract the spring force more strongly in the case of a more greatly deflected part than in the case of a less greatly deflected part. The spring accumulator comprises such a spring unit. The actuator comprises such a spring unit and/or such a spring accumulator.

This application is the National Stage of International Application No. PCT/EP2016/073135, filed Sep. 28, 2016, which claims the benefit of German Patent Application No. 10 2015 218 851.5, filed Sep. 30, 2015. The entire contents of these documents are hereby incorporated herein by reference.

### BACKGROUND

The present embodiments relate to a spring unit, a spring accumulator, and an actuator.

Spring elements are used often in mechanical engineering. For example, mechanical accumulators in the form of spring accumulators are widespread. Spring elements typically include a part that may be deflected with a deflection s. A spring force acts with a spring stiffness k on the part that may be deflected in accordance with Hooke's law:

F=k·s.

The spring force thus increases with increasing deflection of the part that may be deflected.

For example, actuators include spring elements as described above. Actuators of this kind, and thus also the spring elements, are typically deflected, where the spring elements are often part of spring accumulators, either explicitly (e.g., as additional components with accumulator function) or implicitly (e.g., as components such as piezoelectric stacks or seal elements, such as bellows of appropriate stiffness). The characteristics of the actuator (e.g., force profile and speed profile) therefore do not have the desired form over the deflection, since the spring force of the spring elements is dependent on the extent of the deflection. This provides that the dependency on deflection is too great for many applications.

It is known to use spring elements that have low stiffness so that the spring force in the event of deflection is limited.

Such solutions, however, provide disadvantageously sensitive limitations in the parameter selection for these spring elements.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, an improved spring unit including a spring element, in which dependency of a spring force on a deflection has a less disruptive effect, is provided. In another example, an improved spring accumulator and an improved actuator are provided.

The spring unit according to one or more of the present embodiments includes at least one spring element that has a part that may be deflected against a spring force, and a compensation device. The compensation device is configured, at least along a segment along which the part may be deflected, to counteract the spring force more strongly in the case of a more greatly deflected part than in the case of a less greatly deflected part. The segment may include, for example, the case of vanishing deflection. The segment may include all paths that may be described by the part with the deflection thereof, below a maximum path or path value.

A part of a spring element that may be deflected, within the sense of the present embodiments, for example, provides a free end of a compression spring or tension spring or a freely movable non-end or non-edge region of a spring element (e.g., the disc center of a disc spring).

The compensation device thus advantageously counteracts the dependency of the spring force on the deflection of the part that may be deflected. In this way, a spring unit and, for example, a spring accumulator including a spring unit of this kind, and an actuator with a significantly reduced deflection dependency of the application of force on the free part of the spring element may be formed. The significant reduction of this dependency of the application of force thus opens up new fields of use for spring accumulators and actuators that previously were not available on account of the dependency.

Due to the compensation device, the influence of the dependency of the spring force on the deflection may be eliminated. This is important, for example, in the case of metal or diaphragm bellows that provide a metallic seal alongside length compensation. These bellows form spring elements and have a certain stiffness, whereby a force is built up in the event of a deflection. In accordance with one or more of the present embodiments, this influence of force may be easily reduced. For example, it is not necessary to use a bellows that is as soft as possible.

In the spring unit according to one or more of the present embodiments, the compensation device may include a body that may be deflected together with the part along a path, and also one or more clamping jaws that clamp the body in the direction transverse to the path.

In a development of the spring unit, the body has a convex contour as considered in the direction of the one or more clamping jaws. In this way, a force counteracting the spring force may be exerted onto the body by a clamping action.

In the spring unit according to one or more of the present embodiments, the contour when the part is not deflected may have a tangent on the one or more clamping jaws that is parallel to the path. The one or more clamping jaws thus behave in a neutral manner on the part when the part is not deflected.

In the case of the spring unit according to one or more of the present embodiments, the contour of a more strongly deflected part may have a tangent on the one or more clamping jaws that is inclined relative to the path. An increasing force counteracting the spring force may be applied to the part accordingly.

In a development, the contour of the spring unit is an outer contour. Alternatively or additionally, the contour is an inner contour.

In the case of the spring unit according to one or more of the present embodiments, the body may be resilient. The spring accumulator according to one or more of the present embodiments includes a spring unit as described above.

In the spring accumulator according to one or more of the present embodiments, the compensation device may be formed with a spring accumulator. The, for example, resilient body between the clamping jaws may function as a further energy accumulator of this kind (e.g., the entire spring accumulator inclusive of compensation device functions in this development as an energy accumulator).

The actuator according to one or more of the present embodiments includes a spring unit as described above and/or a spring accumulator as described above. The functionality of the actuator may thus be significantly improved, since in accordance with the present embodiments, the force-path characteristics of an actuator of this kind are not influenced by spring elements, as are formed, for example, by metal or diaphragm bellows. This is important, for example, in the case of smaller actuators (e.g., microactuators), since the force-path reserves are usually low and even small spring stiffnesses may have a large negative influence.

### BRIEF DESCRIPTION OF THE DRAWINGS

FIG. 1a shows, schematically in longitudinal section, a spring accumulator with a spring unit according an embodiment of an actuator with two spring elements with a deflectable part shown in a non-deflected position;

FIG. 1b shows, schematically in longitudinal section, the spring accumulator of FIG. 1a, with the deflectable part deflected further compared to FIG. 1a;

FIG. 1c shows, schematically in longitudinal section, the spring accumulator of FIG. 1a, in which the deflectable part is deflected further compared to FIG. 1b;

FIG. 2a shows, schematically in longitudinal section, a further exemplary embodiment of a spring accumulator; and

FIG. 2b shows, schematically in longitudinal section, a third exemplary embodiment of a spring accumulator.

### DETAILED DESCRIPTION

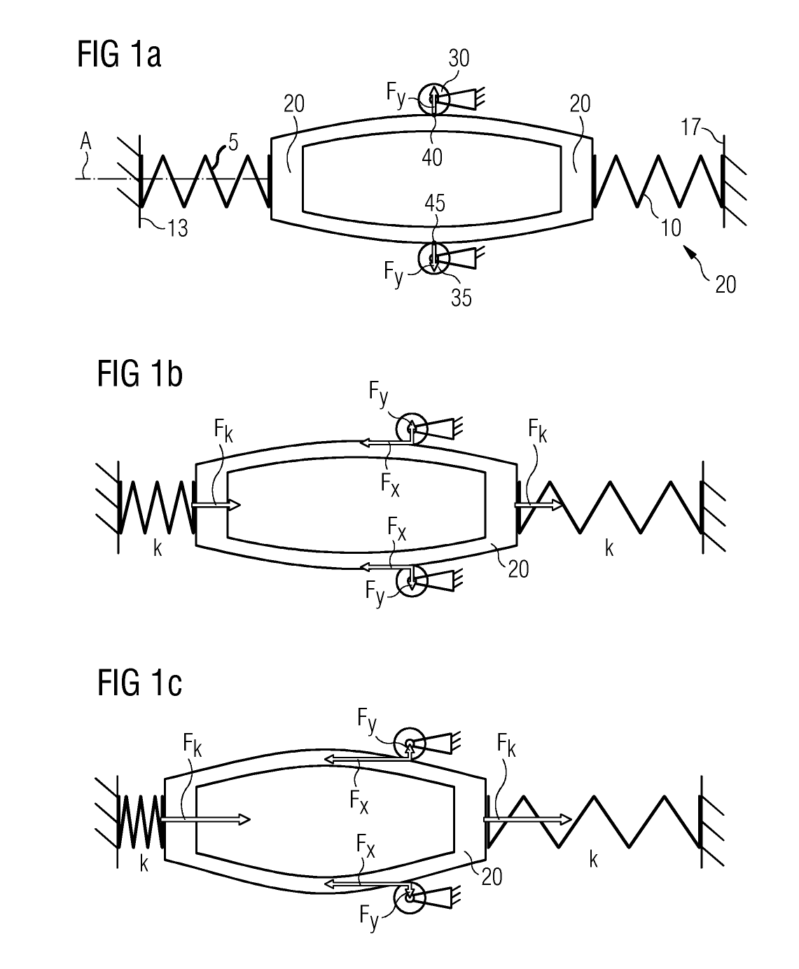

The spring accumulator shown in FIGS. 1a, 1b and 1c include two compression springs 5, 10 with spring constant k that may each be deflected along an axis A. The compression springs 5, 10 are arranged oppositely from two sides 13, 17 that face towards one another and are immobile relative to one another, of an actuator (not shown in detail). The compression springs 5, 10 are oriented with deflection directions in alignment with one another (and with the axis A). The two compression springs 5, 10 are connected to one another on sides, facing away from one another, of a clamping body 20 of a compensation device for compensation of the spring force Fₖ of the compression springs 5, 10, which spring force is dependent on the deflection.

The clamping body 20 has a longitudinal section that remains the same in different cuts parallel to the drawing plane (e.g., the clamping body 20 forms a general mathematical cylinder, the generatrix of which runs perpendicular to the drawing plane). The outer contour 25 of the longitudinal section of the clamping body 20 has a convex curved course, as considered outwardly in the direction perpendicular to the axis A.

The clamping body 20 bears, in a direction perpendicular to the axis A, against two clamping jaws 30, 35 that are oriented as roller bearings with rolling axes perpendicular to the drawing plane and are arranged fixedly relative to the sides 13, 17 of the actuator. In further exemplary embodiments (not shown specifically), the clamping jaws may also be formed as plain bearings.

The clamping body 20 is formed in a flexible manner and is clamped by the clamping jaws 30, 35, and at the same time is compressed in the direction perpendicular to the axis A and within the drawing plane. In the non-deflected position of the clamping body 20 according to FIG. 1a, the tangent at the location 40, 45 of the clamping jaws 30, 35 runs on the outer contour of the clamping body 20 parallel to the axis A. Thus, no force results, oriented along the axis A, from the clamping jaws 30, 35 on the clamping body 20. As a result of the clamping jaws 30, 35, merely a force component F_{y} perpendicular to the axis results from each clamping jaw 30, 35. The force components are oriented oppositely one another. Since, as a result of the absence of deflection of the clamping body 20, there is also no spring force Fₖ acting on the clamping body, there is, overall, no force acting on the clamping body 20.

With increasing deflection (FIG. 1b), the clamping body 20 experiences an increasing spring force as a result of the stronger deflection of the compression springs 5, 10. In addition, however, compared to the above-described arrangement, the clamping body bears differently against the clamping jaws 30, 35. Due to the deflection of the clamping body 20, the tangent on the outer contour of the clamping body 20, at the location 40, 45 of the clamping jaws 30, 35, for example, no longer runs parallel to the axis A, and instead is slightly inclined relative thereto in each case. Here, these tangents on the outer contour of the clamping body 20 enclose with one another an angle that is open in the direction of the deflection. As a result of this inclined bearing of the clamping jaws 30, 35 against the clamping body 20, the clamping body experiences a force in the direction of the deflection (e.g., the force conveyed by the clamping jaws 30, 35 now includes, besides the component F_{y} perpendicular to the axis A, also a force component Fₓ parallel to the axis A that supports the deflection; weakens the spring force counteracting the deflection of the clamping body 20).

With a further deflection of the clamping body 20, the clamping jaws 30, 35, on account of the convex outer contour of the clamping body 20 (e.g., as considered outwardly in the direction perpendicular to the axis A), bear against a point such that the tangents on the outer contour at the location of the clamping jaws 30, 35 enclose a larger angle with the axis A compared to the position according to FIG. 1b. The force component Fₓ parallel to the axis A increases accordingly. The spring force on the clamping body 20 increasing further with stronger deflection of the clamping body 20 is weakened with a further increased force component Fₓ.

The contour of the clamping body 20 in the shown exemplary embodiment has such a course that the total force acting on the clamping body 20 along the axis A is practically constant (e.g., is practically independent of the deflection of the clamping body 20).

In the extreme case, the outer contour of the clamping body 20 may be selected in a further exemplary embodiment (not shown specifically) such that the force Fₓ conveyed by the clamping jaws 30, 35 always offsets the spring force Fₖ on the clamping body 20. The clamping body 20 thus remains free of force with each deflection. Consequently, the clamping body 20 is stopped in each deflected position in exemplary embodiments of this kind.

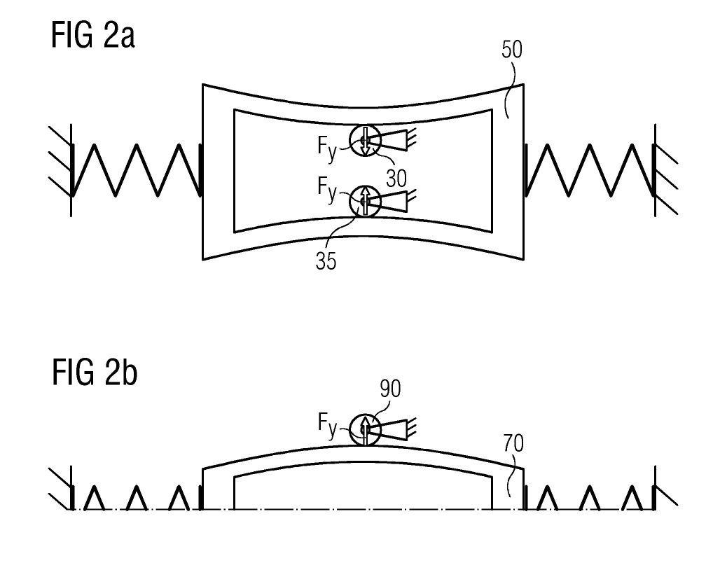

The clamping jaws 30, 35 do not have to act on the outer contour of the clamping body 20 as presented above. Rather, the clamping body 20 may have a corresponding inner contour that is acted on by the clamping jaws 30, 35, as shown in FIG. 2a.

The clamping body 50 presented in FIG. 2a has the form of a hollow general mathematical cylinder (e.g., the base of the cylinder is biconnected and has the topology of a circular ring that in the present case is suitably deformed). The clamping body 50, in planes parallel to the drawing plane, has an inner contour that has a convex shape as considered from the part of the clamping body 50 bearing against each inner clamping jaw 30, 35 in the direction of the clamping jaws 30, 35.

In this exemplary embodiment, the spring force may be suitably compensated, may be linearized in relation to the deflection, and/or may be cancelled out completely.

The clamping body does not have to have the form of a general mathematical cylinder. Rather, the clamping body may also have a rotationally symmetrical design, as shown in FIG. 2b. The clamping body 70 shown in FIG. 2b has the same longitudinal section as the clamping body 20 shown in FIGS. 1a to 1c. In contrast to the clamping body 20, the clamping body 70, however, results from rotation of the longitudinal section about the axis A. The clamping jaws 90 are in this case ball bearings.

In a further exemplary embodiment (not shown specifically), the clamping body results from rotation of the longitudinal section of the clamping body 50. In this case as well, the clamping jaws (not shown specifically) are provided by ball bearings.

In further exemplary embodiments (not shown specifically), which, for the rest, correspond to those described above, the spring elements do not satisfy Hooke's law. Rather, in many cases encountered in practice, the spring constant is not an actual constant, and instead, is dependent on the deflection s. The spring force, therefore, has a non-linear dependency of the spring force F on the deflection s:

F=k(s)*s,

where k(s) describes the spring stiffness now dependent on the deflection. In this case, the clamping body 20 may be configured to compensate for the spring force that follows from this non-linear characteristic or to compensate or weaken the increase/decrease thereof with increasing deflection.

In order to compensate for a non-linear spring force of this kind in the entire deflection range, the form of the clamping body is modified compared to the drawing. If, for example, k(s) increases with the deflection s, the curvature of the clamping body in the non-deflected position thereof is to be lower and is to be higher accordingly at the edge compared to that shown in FIG. 1 and FIG. 2. If k(s) decreases with the deflection s, the curvature of the clamping body in the middle thereof is higher and is lower at the edge thereof accordingly.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A spring unit comprising:
at least one spring element that has a part that is deflectable against a spring force; and
a compensation device configured to counteract the spring force more strongly in the case of a more greatly deflected part than in the case of a more weakly deflected part.

2. The spring unit of claim 1, wherein the compensation device comprises:
a body that is deflectable with the part along a path; and
one or more clamping jaws configured to clamp the body in a direction transverse to the path.

3. The spring unit of claim 2, wherein the body has a convex contour in a direction of the one or more clamping jaws, at least as considered from a part of the body bearing against the one or more clamping jaws.

4. The spring unit of claim 1, wherein the convex contour when the part is not deflected has a tangent on the one or more clamping jaws that is parallel to the path.

5. The spring unit of claim 3, wherein the convex contour when the part is more strongly deflected has a tangent on the one or more clamping jaws that is inclined relative to the path.

6. The spring unit of claim 3, wherein the convex contour is an outer contour.

7. The spring unit of claim 3, wherein the convex contour is an inner contour.

8. The spring unit of claim 1, wherein the body is resilient.

9. A spring accumulator comprising:
a spring unit comprising:
at least one spring element that has a part that is deflectable against a spring force; and
a compensation device configured to counteract the spring force more strongly in the case of a more greatly deflected part than in the case of a more weakly deflected part.

10. The spring accumulator of claim 9, wherein the compensation device is formed with a spring accumulator.

11. An actuator comprising:
a spring unit comprising:
at least one spring element that has a part that is deflectable against a spring force; and
a compensation device configured to counteract the spring force more strongly in the case of a more greatly deflected part than in the case of a more weakly deflected part.

12. The spring accumulator of claim 9, wherein the compensation device comprises:
a body that is deflectable with the part along a path; and
one or more clamping jaws configured to clamp the body in a direction transverse to the path.

13. The spring accumulator of claim 12, wherein the body has a convex contour in a direction of the one or more clamping jaws, at least as considered from a part of the body bearing against the one or more clamping jaws.

14. The spring accumulator of claim 9, wherein the convex contour when the part is not deflected has a tangent on the one or more clamping jaws that is parallel to the path.

15. The spring accumulator of claim 13, wherein the convex contour when the part is more strongly deflected has a tangent on the one or more clamping jaws that is inclined relative to the path.

16. The spring accumulator of claim 13, wherein the convex contour is an outer contour.

17. The spring accumulator of claim 13, wherein the convex contour is an inner contour.

18. The spring accumulator of claim 1, wherein the body is resilient.
